(19) United States
(12) Patent Application Publication
(10) Pub. No.: US 2003/0059243 A1
(43) Pub. Date: Mar. 27, 2003

(54) Replacement key and computer keyboard which incorporates the same

(76) Inventor: Rich Lang, Atlanta, GA (US)

Correspondence Address: ROBERT R. WATERS, ESQ., WATERS LAW OFFICE, PLLC, 633 SEVENTH STREET, HUNTINGTON, WV, 25701, US

(21) Appl. No.: 09/961,494

(22) Filed: Sep. 24, 2001

(51) Int. Cl. B41J 5/14

(52) U.S. Cl. 400/490

(57) ABSTRACT

A replacement key cap and key cap system designed and constructed to enable a user to improve performance by selectively limiting access to individually selected keys on a standard or custom keyboard or data entry system. The replacement cap consists of a cap featuring a small cross-sectional top surface to be press mounted or otherwise attached to a key cap shaft or protrusion from an existing keyboard system. In a preferred embodiment, the replacement key cap system features a cross-sectional area only slightly larger than the cross-sectional area of the key shaft or support member and features a lower profile than adjacent pre-existing keys.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention relates generally to computer keyboards such as those utilized with personal computers, typewriters and similar devices. Specifically, this invention relates to a low-profile replacement key for a keyboard, such as a computer keyboard, which will enable the user to improve typing performance and reduce the prevalence of accidental striking of little-used keys on a keyboard by replacing them with a key that is less likely to be accidentally engaged.

In today's world, the use of a computer keyboard has become a basic, threshold requirement for communication and business transactions, almost to the extent of replacing the basic pen and pencil. With nearly all business communications transmitted via word processing, the fast and efficient use of a computer keyboard is essential to all of us. In addition, with the rise in popularity of the Internet and electronic mail, the computer keyboard has also become a threshold instrument in the transaction of personal correspondence. Furthermore, as electronic banking and electronic commerce continues to gain prevalence, the keyboard once again emerges as a threshold instrument of daily use.

However, although the computer keyboard has become basic and necessary, keyboarding skills vary widely among the populace. For those who are skilled typists or have access to good secretarial assistance, communication is fast, efficient, and effective. However, many people are limited for one reason or another in the finger dexterity required to master a computer keyboard or a typewriter. For example, an individual may have a hand injury, arthritis, or may simply have not developed good finger dexterity such as to efficiently operate a computer keyboard. For such an individual, communication and transactions may be unnecessarily complicated. Furthermore, as the importance of electronic transactioning continues to rise, all of us have little room in our lives for erroneous keystrokes.

While computer keyboards have become more commonplace and essential, keyboards have also become more complicated in recent years with the addition of more and more keys. While the basic alphanumeric layout is standardized among keyboard manufacturers, the peripheral keys, i.e.,—those residing around the edges of the alphabetic layout, vary to some extent from manufacturer to manufacturer. One feature of many keyboards that is often problematic for the infrequent typist or one who is only minimally skilled in keyboard use is the prevalence of little-used keys in close proximity to keys used frequently. A little-used key, located in close proximity to a frequently-used key can be troublesome, and may account for an inordinate percentage of keystrike errors, resulting is lost productivity or erroneous transactions.

For many people, a prime example of a problematic key is the “Caps Lock” key, which is located in the lower left of many keyboards adjacent to the letter “A”. The Caps Lock feature is rarely used in basic typing while the adjacent key, the letter “A” is a highly used key in word processing. Both keys are also usually operated by means of the left pinky finger of the user, which is usually the finger which features the least amount of dexterity and precision. Accordingly, it is quite common for the Caps Lock key to be accidently engaged in the middle of a sentence, to the consternation of the user. Much time can be wasted correcting wild capital letters in the middle of a sentence. A means is needed for selectively blocking certain keys at the discretion of the user in order to limit the occurrence of an accidental keystroke.

### DESCRIPTION OF THE RELATED ART

A number of prior art patents attempt to deal with alterations to a standard keyboard with respect to key height, placement, or construction, and are analogous in some respects. Among those patents, U.S. Pat. No. 6,091,530 to Lanzetta et al. discloses and claims a keyboard apparatus which features retractable keys. In the Lanzetta device, the keypad features an inflatable airbag under the keys which may be used to raise the keys when the keyboard is in use in order to create the needed keystroke distance. Lanzetta has particular utility in the area of portable or laptop computers, wherein a smaller more compact keyboard is desirable. When the keyboard is not in use, it may be deflated.

U.S. Pat. No. 5,971,637 to Malhi et al. discloses a low profile keyboard for use primarily in portable electronic devices. The keyboard includes a guide mechanism coupled to the keycap for controlling the height of the key. The keypad, in essence, is spring loaded, and when the keypad is not in the active state, the spring mechanism may be disengaged such that the keyboard can be stored at a lower height. In a similar vein, U.S. Pat. No. 6,056,456 to Kinoshita claims an adjustable volume keyboard which allows the intervals and height of the keys to be changed either horizontally or vertically. The Kinoshita device is limited, however, in that while the relative vertical or horizontal profile of the keyboard may be altered, the bases of the various key switches are connected with the adjacent key such that the key switches in a given group are fixed in relation to each other.

U.S. Pat. No. 5,757,292 to Amro et al. claims a removable keyboard cap extension apparatus whereby a subset of keys on a keyboard may be raised to a new height above and beyond the balance of a keyboard. The Amro device has particular utility in situations in which an entire keyboard is not needed; for example, where only a few keys are needed to process essentially digital functions. In such a situation, a full range of alphanumeric characters only makes the operation more difficult when only a small number of keys will be used repeatedly.

U.S. Pat. No. 5,767,463 to Gandre claims an improved keyboard with a lower overall profile which allegedly is not limited in the overall range of key travel. In the Gandre keyboard, the activation surface of the keycap is slanted down and away from the user. In one embodiment, the activation surface is substantially perpendicular to the travel axis wherein the inventor claims improved ergonomics of control as well as a smaller keyboard without a reduction in the key travel range.

U.S. Pat. No. 6,056,457 to Chao discloses a keyboard in which the overall keyboard fitness is altered by provisions of incorporating metal plates of alternative thicknesses to the keyboard backing. Chao claims advantages in manufacturing ease in situations in which users may desire a metal plate backing on a keyboard in order to strengthen the structure of the keyboard. Chao does not address the functioning of individual keys relative to each other, or overall ease of operation.

A wide assortment of other prior and contemporary art patents may also be found which address computer key arrangements in general. Among those, U.S. Pat. No. 5,842,798 to Su provides one embodiment of a push button computer key with a retention groove defining portion. U.S. Pat. No. 5,911,317 to Tsai features metal plated rubber computer keys that are light permeable. U.S. Pat. No. 6,022,157 to Shih-Hung features a keyboard constructed for improved ease in maintenance greasing. U.S. Pat. No. 5,813,777 to Bonnstauffer is representative of an assortment of patents that detail padded or “stress-relieving” computer keys. The overall goal in such patents is to improve ergonomics and relieve impact stress upon the fingers of the keyboard user.

Although the prior art devices address important issues impacting the placement of computer keyboard keys, it is clear that none of the prior art systems provides a user with the flexibility to limit access to specific keys that are problematic to the individual or to vary the lateral orientation of said keys to improve an individual's performance.

### SUMMARY OF THE INVENTION

In accordance with the present invention, the keyboard system disclosed consists generally of a standard keyboard device, including a plurality of key switches designating a different alphanumeric character(s). The key switches are moved in an essentially vertical direction to engage a switch contact located below in order to operate a command to a central processor system. The key switches are further comprised of a spring assembly or the equivalent located between the key cap and the switch contact below such as to enable a key to be depressed to register a character and then return to an undepressed state for the next key operation. The keys are arranged in a generally standard arrangement corresponding to a typewriter layout, although other arrangements are possible.

The replacement key cap system disclosed and claimed in this invention is designed and constructed to enable a keyboard user to improve performance by selectively limiting access to individually selected keys which pose particular problems for the user, and which have limited utility to the user. Accordingly, the primary objective of the present invention is to provide a keyboard in which individual keys can be changed at the discretion of the user. The keyboard disclosed is intended to be flexible in order to allow the decision about which keys are to feature a reduced profile to vary from user to user.

Another objective of this invention is to create a keyboard mechanism in which the key replacement function is quick and easy to accomplish. At the same time, although the keys should be easily removable for replacement, the keys must be firm and tightly mounted when in use such as to not become accidentally disengaged during use. Accordingly, the keyboard system disclosed herein is a durable mechanical device which will withstand all the rigors that standard keyboards will take throughout the industry. The keyboard will be constructed within industry standards and tolerances and not deviate from the industry norm, other than the improvement features discussed herein.

Another primary objective of the present invention is to provide an alternative keyboard system that is cost effective and easy to manufacture. To meet this objective, the keyboard will be constructed of standard materials such as hard plastic and will be designed to accomodate automated production of the units, thereby minimizing cost.

Yet another objective of this invention is to construct individual replacement keys that are fully interchangeable with the keys of leading keyboard manufacturers to accommodate use as a retrofit system. The seats of the replacement keys will be constructed such as to couple with the key sockets of the major manufacturers of keyboards.

As discussed above, the keyboard and replacement keys of the present invention overcome the disadvantages inherent in conventional keyboards available in prior art devices. The present invention effectively provides an alternative key and keyboard system. In this regard, before explaining at least one embodiment of the invention in detail, it is to be understood that the invention is not limited in its application to the details of construction and to the arrangements of the keyboard articles set forth in following description or illustrated in the drawings. The invention is capable of other embodiments and of being practiced and carried out in various and diverse ways. Also, it is to be understood that the phraseology and terminology employed herein are for the purposes of description and should not be regarded as limiting.

Accordingly, those skilled in the art will appreciate that the concept upon which this invention is based may readily be utilized as a basis for the design of other structures, methods, and systems for carrying out the several purposes of the present invention. It is important, therefore, that the claims be regarded as including such equivalent constructions insofar as they do not depart from the spirit and scope of the present invention.

Furthermore, the purpose of the foregoing Abstract is to enable the U.S. Patent and Trademark Office and the public generally, and especially including the practitioners in the art who are not familiar with patent or legal terms or phraseology, to determine quickly from a cursory inspection, the nature and essence of the technical disclosure of the application. The Abstract is neither intended to define the invention or the application, nor is it intended to be limiting to the scope of the invention in any way.

### BRIEF DESCRIPTION OF THE DRAWINGS

The aforementioned objectives, utility, features and advantages of this invention will become more fully apparent to those skilled in the art by reference to the following drawings, wherein the keyboard system and replacement key of the present invention are described more fully. Reference numerals designate various elements of the keyboard system as discussed in the Detailed Description and shown in the drawings as follows:

FIG. 1 shows a standard keyboard layout and arrangement of keys as per prior art devices;

FIG. 2 is a planned view of a portion of a standard computer keyboard showing the layout of the keys, prior to application of the replacement keys of the present invention;

FIG. 3 is a planned view of a portion of a computer keyboard showing the application of a replacement key for the Caps Lock as per the present invention;

FIG. 4 is a side view of a standard computer key in prior art devices in the undepressed or idle state;

FIG. 5 is a side view of an individual computer key, modified such as to include the replacement cap of the present invention.

### DETAILED DESCRIPTION

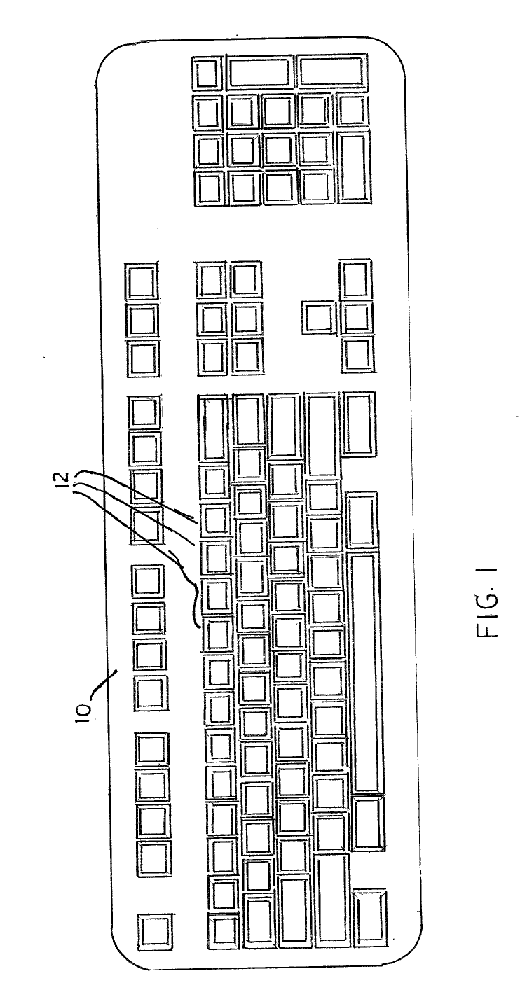

With reference to the drawings, the present invention is comprised of a plurality of components functioning in a general sense as a replacement key system and keyboard which incorporates the same. In the broadest embodiment, the system includes a keyboard having a plurality of individual keys which are operated by the application of pressure vertically. As shown in FIG. 1, the present invention includes a keyboard 10 for use in a computer system. The keyboard system can include a plurality of standard keys 12 as further shown in FIG. 1.

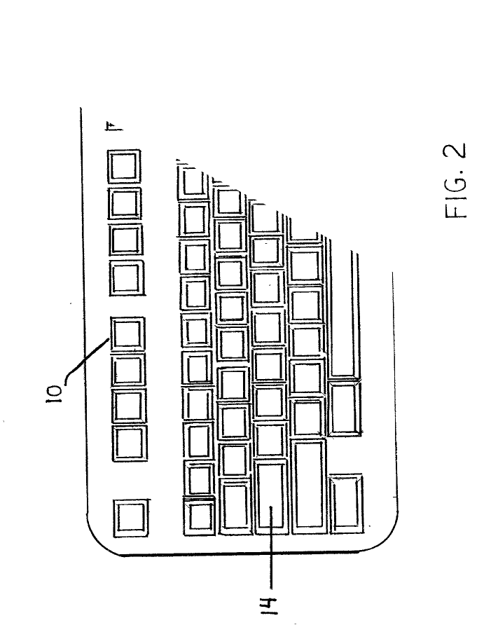

FIG. 2 shows a close-up plan view of a standard prior art keyboard featuring a standard key layout. As shown, each key features a generally square planar top surface of relatively equal proportions, with the exception of a small number of oversized keys 14, including the Caps Lock key. As indicated in the drawing, the keys are typically spaced very close to each other with only enough space in between to allow the free movement of the keys in the vertical direction. Such placement of the keys is convenient and appropriate for individuals reasonably skilled in typing. However, for those generally unskilled in keyboarding, the prevalence of little-used keys is a source of frequent error.

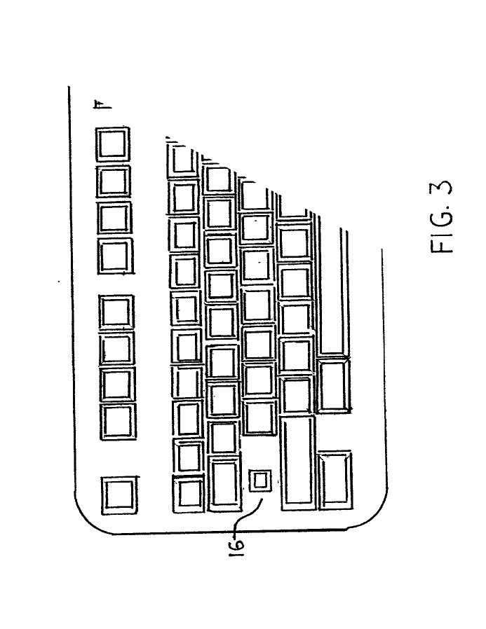

FIG. 3 shows a portion of a standard computer keyboard 10 modified such that the replacement cap 16 of the present invention has been incorporated to replace the “Caps Lock” key. As shown in the drawing, utilization of the replacement key results in essentially removing a primary source of error from the keyboard assembly. Not only is the Caps Lock a key that is rarely utilized in typing, it is a key that is generally actuated by means of the user's left pinky finger. Of course, the left pinky finger is generally the finger which features the least amount of dexterity with most people. Accordingly, the removal of the oversized Caps Lock key, or even a standard size key such that the same is replaced with the key of the present invention may be helpful to many users.

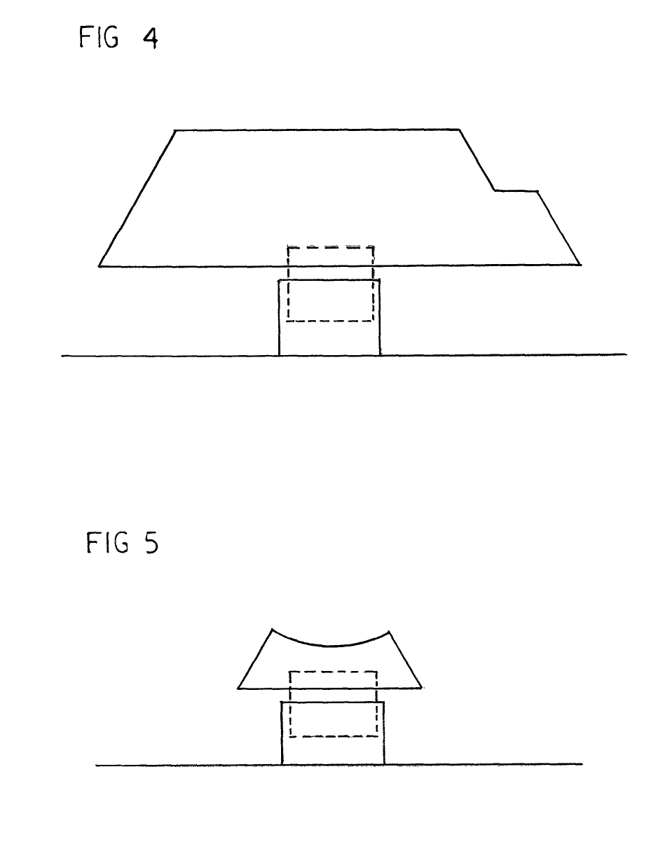

FIG. 4 shows a side view of a standard computer key in prior art devices in the idle or undepressed state. By contrast, FIG. 5 shows the side view of a replacement key as per the present invention. As can be easily seen, the replacement key of the present invention is not only smaller in overall surface area, but the preferred embodiment features a key that is shorter in height as well. Accordingly, by shortening the height, it is possible to further remove the key in question from accidental actuation. The degree to which the height of a key can be altered with the present invention will vary from keyboard to keyboard since there is some variability in standard keyboards in terms of height of the receiving shaft and in overall travel distance of a depressed key.

I claim:

1. A removable keyboard cap to be used in a keyboard wherein said keyboard consists of a support chassis and a plurality of keys arranged in a planar configuration with each key supported independently by a vertical support column extending from said support chassis, said keyboard cap comprising:
a). one or more removable keyboard caps for one or more keys constructed such that the upper planar surface area of said cap is less than the upper planar surface area of said plurality of keys; and
b). attachment means for securing said one or more keyboard caps to said vertical columns extending from said support chassis such that depression of said removable keyboard caps results in actuation of said key and/or the transmission of data.

2. The removable keyboard cap of claim 1 wherein the upper planar surface area of said keyboard cap is approximately equal to the upper planar surface area of said vertical support column.

3. The removable keyboard cap of claims 1 wherein said attachment means for securing said one or more keyboard caps to said vertical columns comprises a snap-on means for attaching said removable keyboard cap to said vertical support column.

4. The removable keyboard cap of claims 1 wherein said attachment means for securing said one or more keyboard caps to said one or more vertical support columns comprises a spring-loaded tensioning mechanism for attaching said keyboard cap to said vertical support column.

5. A retrofit system for the replacement of one or more keyboard caps in a keyboard wherein said keyboard consists of a support chassis and a plurality of keys arranged in a planar configuration with each key supported independently by a vertical support column extending from said support chassis, said keyboard cap comprising:
a. one or more removable keyboard caps for one or more keys constructed such that the upper planar surface area of said cap is less than the upper planar surface area of said plurality of keys; and
b. attachment means for securing said one or more keyboard caps to said vertical columns extending from said support chassis such that depression of said removable keyboard caps results in actuation of said key and/or the transmission of data.

6. The retrofit system of claim Five wherein the upper planar surface area of said keyboard cap is approximately equal to the upper planar surface area of said vertical support column.

7. The retrofit system of claims Five wherein said attachment means for securing said one or more keyboard caps to said vertical columns comprises a snap-on means for attaching said removable keyboard cap to said vertical support column.

8. The retrofit system of claims Five wherein said attachment means for securing said one or more keyboard caps to said one or more vertical support columns comprises a spring-loaded tensioning mechanism for attaching said keyboard cap to said vertical support column.
